(19) United States
(12) Patent Application Publication
(10) Pub. No.: US 2008/0215996 A1
(43) Pub. Date: Sep. 4, 2008

(54) Website/Web Client System for Presenting Multi-Dimensional Content

(75) Inventors: Fernando A. Vega, Los Angeles, CA (US); Jean-Guy Hardy, Ottawa (CA)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Chad Farrell Media, LLC, Los Angeles, CA (US)

(21) Appl. No.: 11/678,020

(22) Filed: Feb. 22, 2007

(51) Int. Cl. G06F 3/00; G06F 17/00

(52) U.S. Cl. 715/760; 715/234; 707/104.1

(57) ABSTRACT

A system for presenting multi-dimensional content includes a computer network; a server computer; and, a client computer coupled to the server computer through the computer network. The client computer has a browser software executing thereon implementing a method of presenting multi-dimensional content in the client computer. The method includes transmitting an identifier; receiving a hierarchical document generated based on the identifier; and, rendering a graphical user interface (GUI) based on the hierarchical document.

### BACKGROUND

1. Field

The present invention relates generally to Internet browser software and, more particularly, to a website/web client system for presenting multi-dimensional content.

2. Background

Conventional web browsers only display one web page at a time, typically using the full area of the screen. Web page designers are responsible for providing website navigation controls, such as menu bars and buttons, and organizing a multitude of single web pages to construct a website. However, users may also use the “Back” and “Forward” buttons of web browsers to navigate the website, and that adds another layer of complexity into the website design process when handing functionality such as form posting or other web browser state-dependant functions. Further, if a user wants to view more then one web page at a time, then the user must open a new instance of the web browser window.

Some web browsers, such as the Firefox web browser from Mozilla Corporation, use tabbed browsing to assist users in managing the viewing of multiple web pages. However, this type of web browsing system is not “site aware.” In other words, website developers cannot make use of the tab functionality (e.g., website developers cannot control any other tabs from within the tab in which their web page is loaded).

As a result, users must now manage multiple windows of web browser instances or, where a “tabbed web browser” is being used, be limited to viewing one tab at a time. Further, although many websites and applications provide communications services such as instant messaging (IM), chat rooms, e-mail, and other modes of communication, users must add further clutter to their screens to use these services.

It is desirable to have a web browser that addresses the issues above and provide a system that can manage and present complex websites in an organized and useful fashion. It is also desirable to have a web browser that will allow a user to manage and use multiple communication modalities in one integrated interface.

### SUMMARY OF THE PREFERRED EMBODIMENTS

The present invention allows the presentation of complex multi-dimensional content in a more organized fashion. In one preferred embodiment, the present invention is embodied in a system for presenting multi-dimensional content includes a computer network; a server computer; and, a client computer coupled to the server computer through the computer network. The client computer has a browser software executing thereon implementing a method of presenting multi-dimensional content in the client computer. The method includes transmitting an identifier; receiving a hierarchical document generated based on the identifier; and, rendering a graphical user interface (GUI) based on the hierarchical document.

In another preferred embodiment, a method for presenting multi-dimensional content in a client includes transmitting an identifier; receiving a hierarchical document generated based on the identifier; and, rendering a graphical user interface (GUI) based on the hierarchical document.

In yet another preferred embodiment, a computer readable medium includes computer-executable code that, when executed, implements a method of presenting multi-dimensional content in a client. The method includes transmitting an identifier; receiving a hierarchical document generated based on the identifier; and, rendering of a graphical user interface (GUI) based on the hierarchical document.

The present invention also provides a system for a first user to manage access, by a second user, of a plurality of restricted access images stored on a server computer. In one preferred embodiment of this aspect of the present invention, the server computer includes computer readable medium having computer executable code that, when executed, implements a method. The method includes receiving, from the second user, an access request to access the plurality of restricted access images stored on the server computer; presenting, to the first user, the request from the second user to access the plurality of restricted access images stored on the server computer; receiving, from the first user, a first access grant selection for a first image from the plurality of restricted access images stored on the server computer for the second user; and, associating the first access grant selection and the first image from the plurality of restricted access images stored on the server computer with the second user.

In another preferred embodiment, a method for a first user to manage access, by a second user, of a plurality of restricted access images includes receiving, from the second user, an access request to access the plurality of restricted access images; presenting, to the first user, the request from the second user to access the plurality of restricted access images; receiving, from the first user, a first access grant selection for a first image from the plurality of restricted access images for the second user; and, associating the first access grant selection and the first image from the plurality of restricted access images with the second user.

In yet another preferred embodiment, a computer readable medium having computer-executable code stored thereon that, when executed, implements a method for a first user to manage access, by a second user, of a plurality of restricted access images.

The method includes receiving, from the second user, an access request to access the plurality of restricted access images; presenting, to the first user, the request from the second user to access the plurality of restricted access images; receiving, from the first user, a first access grant selection for a first image from the plurality of restricted access images for the second user; and, associating the first access grant selection and the first image from the plurality of restricted access images with the second user.

Other objects, features and advantages will become apparent to those skilled in the art from the following detailed description. It is to be understood, however, that the detailed description and specific examples, while indicating exemplary embodiments, are given by way of illustration and not limitation. Many changes and modifications within the scope of the following description may be made without departing from the spirit thereof, and the description should be understood to include all such variations.

### BRIEF DESCRIPTION OF THE DRAWINGS

The invention may be more readily understood by referring to the accompanying drawings, in which:

FIG. 1 is a block diagram illustrating a website/web client system configured in accordance with one preferred embodiment of the present invention, the architecture including a client having a web browser;

FIG. 2 is a screen capture of a graphical user interface (GUI) of the web browser of the client of FIG. 1 configured in accordance with one preferred embodiment of the present invention;

FIG. 3 is a screen capture of the GUI of the web browser where a user can log into a website in accordance with one preferred embodiment of the present invention;

FIG. 4 is a screen capture of the GUI of the web browser where the user has logged into the website in accordance with one preferred embodiment of the present invention;

FIG. 5 is a screen capture of the GUI of the web browser displaying an address book of the user in accordance with one preferred embodiment of the present invention;

FIG. 6 is a screen capture of the GUI of the web browser displaying a search feature in accordance with one preferred embodiment of the present invention;

FIG. 7 is a screen capture of the GUI of the web browser displaying a search result in accordance with one preferred embodiment of the present invention;

FIG. 8 is a screen capture of the GUI of the web browser displaying a predetermined site designated by a tab in the GUI;

FIG. 9 is a screen capture of the GUI of the web browser displaying another predetermined site designated by a tab in the GUI;

FIG. 10 is a screen capture of the GUI where the first user can designate a plurality of pictures as restricted access pictures;

FIG. 11 is a screen capture of the GUI where a second user can request access to the plurality of restricted access pictures of the first user;

FIG. 12 is a screen capture of the GUI where the first user can grant access to the plurality of restricted access pictures to the second user after receiving the request from the second user generated in FIG. 11;

FIG. 13 is a screen capture of the GUI where the second user can access the subset of restricted access pictures from the plurality of restricted access pictures of the first user after the first user has granted permission to the second user in FIG. 12;

FIG. 14 is a screen capture of the GUI of the web browser displaying a private chat room in accordance with one preferred embodiment of the present invention;

FIG. 15 is a screen capture of the GUI of the web browser displaying a public chat room in accordance with one preferred embodiment of the present invention;

FIG. 16 is a screen capture of the GUI of the web browser displaying a closed chat portion of the GUI in accordance with one preferred embodiment of the present invention;

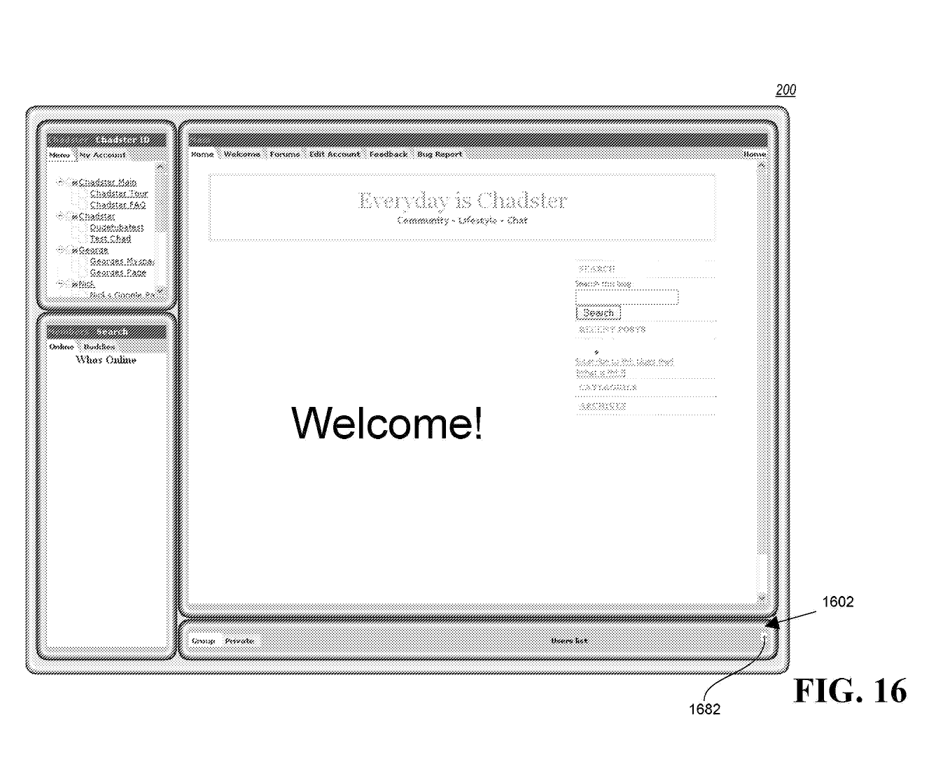

FIG. 17 is a flow diagram illustrating an exemplary operation of the website/web client system in accordance with one preferred embodiment of the present invention;

FIG. 18 is a block diagram of a computer system configured in accordance with one preferred embodiment of the present invention; and.

FIG. 19 is a block diagram of a computer system configured in accordance with one preferred embodiment of the present invention.

Like numerals refer to like parts throughout the several views of the drawings.

### DETAILED DESCRIPTION OF THE PREFERRED EMBODIMENTS

The present invention allows the presentation of complex multi-dimensional content in a more organized fashion. Specifically, the content is presented in a web browser, or client, with a layout having a multi-frame, multi-tiered tabbed architecture that is start-up and runtime configurable. In one preferred embodiment of the present invention, the layout of all graphical elements in the web browser is controlled through the use of a configuration file created using a hierarchical document standard such as the extensible markup language (XML) standard. The configuration file is also referred to herein as a configuration template. For example, the XML document can define a layout with multiple frames where each frame contains up to 2 sets of tabs and each tab may map to a web browser instance or another set of tabs within the same frame. An exemplary layout is illustrated and discussed herein.

In one preferred embodiment of the present invention, the configuration file is web-based. As a result, the configuration of the web browser is highly flexible and dynamic. Further, unlike traditional software applications that obtain configuration data from a disk-based file that is set-up and maintained locally, the web browser of the client is designed to connect to a Hypertext Transfer Protocol (HTTP), or web, server and therefore uses extensive web browser controls. The use of web technology will provide a transparent HTTP session between the client and the web server to perform many of the functions offered on the client.

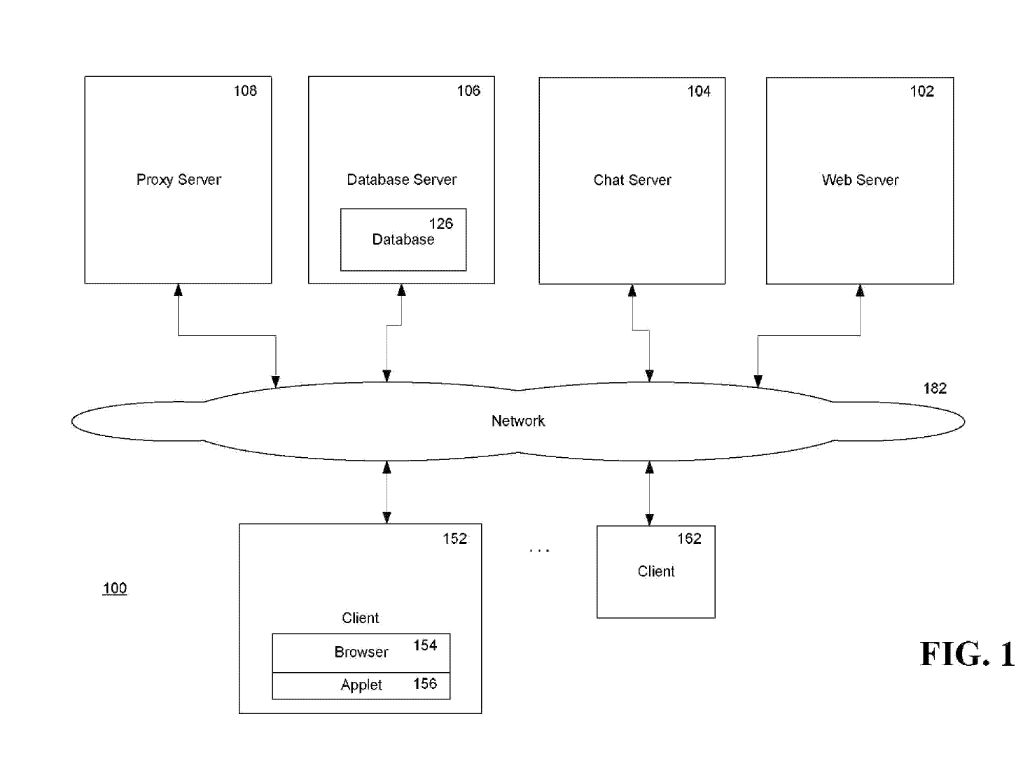

FIG. 1 illustrates a system 100 that is configured in accordance with one preferred embodiment of the present invention, including a web server 102, a chat server 104, a database server 106, and a proxy server 108. A first client 152 and a second client 162 are coupled for communication with the various servers in the system 100 (e.g., the web server 102, the chat server 104, the database server 106 and the proxy server 108) through a network 182. The following description will use the first client 152 as an exemplary client. However, it should be noted that the description can apply to any suitably-configured client (e.g., second client 162) as well. Further, although a specific example of a chat messaging system will be used in the description of the preferred embodiments of the present invention, it should be noted that the inventive aspects are applicable to other messaging systems, such as voice-over-IP (VOIP), audio/video conferencing (including web camera or “webcam” applications), and other real-time messaging systems.

The web server 102 supplies various web pages associated with the websites for which it hosts, initial configuration files, as well as various application-layer modules to the clients in the system 100. In addition, initial authentication of the user will be performed at the web server 102 to establish a web session between the first client 152 and the other servers in the system 100.

In one preferred embodiment of the present invention, a single chat server is used in the system 100. The chat server 104 maintains system-wide state information and will host chat, instant messaging (IM), buddy online/offline notification, webcam, file transfer and peering services to the various clients in the system 100 (e.g., the first client 152 and the second client 162). Clients will be allowed to connect with the chat server 104 after passing the initial authentication process on the web server 102, which will then deposited a validation key with the chat server 104.

The data files used in the system 100 are stored on a database server 106 that interacts mostly with the web server 102. Because the data storage and retrieval operations handled by the database server 106 place heavy demands on the server, it should be noted that additional database servers can be added using a load balancer to create server clusters as needed.

In one preferred embodiment of the present invention, the chat server 104 handles inbound connections from the clients and connecting, disconnecting, packet framing, pinging and buffering messages. In another preferred embodiment, a proxy server such as the proxy server 108 can be added to the system 100 to offload these connectivity functions from the chat server 104, leaving the chat server 104 to process the routing of messages between chat clients. In this other preferred embodiment, additional proxy servers may be added as connection traffic increases. The exact number of these servers will be determined by the maximum connection count desired. For example, assuming the proxy server 108 is a single proxy server that is able to handle up to ten thousand (10,000) concurrent client connections, then two proxy servers will be required to service a maximum expected load of fifteen thousand (15,000) concurrent client connections. The chat server 104 will communicate with proxy server 108 so that each may notify the other in changes of connection status and provide the ability to disable new connections, etc.

In one preferred embodiment of the present invention, the network 182 represents a variety of networks that may include one or more local area networks as well as wide area networks. The functionality provided by the web server 102, the chat server 104, the database server 106, the proxy server 108, the first client 152, and the second client 162, as well as by any other computer systems necessary in the system 100 may be implemented using a computer system having the characteristics of a computer system 1900, as described herein. It should be noted, however, that the specific implementation of the computer system or systems used to describe the present invention is not to be limiting unless otherwise specifically noted. For example, the functionality provided by the web server 102 and the database server 106 may be offered in one computer system. Conversely, the functionality provided by the web server 102 and the database server 106 may be distributed over several computer systems. Multiple server systems and clients, as well as other computer systems and computing devices may also be implemented in the system 100.

As described herein, a user, using software on a client computer such as a browser 154 and an associated applet 156 on the first client 152, interacts with the servers in the system 100. In one preferred embodiment, the browser 154 and the applet 156 will present a graphical user interface (GUI) to the user. In the following description, the GUI is created using one or more web pages (which may be referred to as “pages,” “screens,” or “forms”) provided by web server 102 and rendered by the applet 156 through the use of the browser 154. In one preferred embodiment of the present invention, the applet 156 is an applet programmed using the Java™ programming language as promulgated by Sun Microsystems, Inc., and the browser 154 may be based on any Internet web browser engine, such as the Internet Explorer™ browser provided by Microsoft Corp. In another preferred embodiment of the present invention, a script created using the Javascript™ scripting language, also promulgated by Sun Microsystems, Inc., may be used.

Further, throughout the description of the various embodiments of the invention herein, references are made to the user performing such actions as selecting buttons, inputting information on forms, executing searches or updates. In one preferred embodiment of the present invention, these actions are generated by the user during the user's interaction with the browser 154. For example, one or more pages described herein are electronic forms that include fields in which the user may type to update information in the database 126. Once the user has provided such data, the user may select a button or link on the page to submit the information and cause an update of the database 126 with the information. Specifically, the browser 154 will send the web server 102 the information retrieved from the user using the electronic form, which will cause database 126 to be updated.

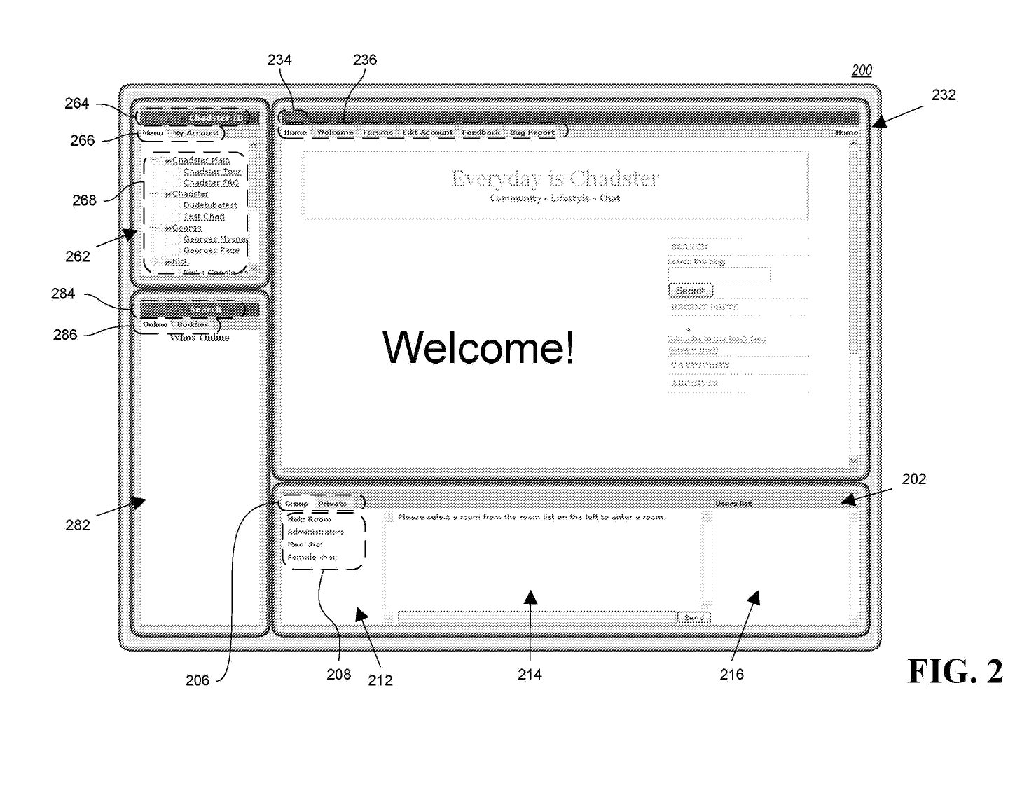

FIG. 2 illustrates a GUI 200 of the first client 152 configured in accordance with one preferred embodiment of the present invention and presented to the user by the browser 154 and the applet 156. The browser 154 supports independent content frames that can be re-sized or re-positioned anywhere within the application window or within another frame using predefined properties and methods. These frames can grow and shrink according to the parent frame (if specified) or remain static in size. Attributes will be defined in the configuration template to handle frame configuration. These frames are part of an array of objects in the application that are referenced by numeric IDs.

As noted herein, in one preferred embodiment of the present invention an XML template is used to describe the initial layout and content of the GUI 200. The GUI 200 is rendered by the applet 156 processing the contents of the XML template to describe the components of a web pages/site, its layout, and the initial starting pages contained in the various frames. Each interface feature of a client is thus configurable via the web server 102 sending the XML template. For example, the web server 102 will be polled by the first client 152 during the initialization of the first client 152 for the configuration information, as described below. Thus, if the user chooses an alternate language or font on the website, then this change will be reflected in the first client 152 automatically at login.

In one preferred embodiment of the present invention, there are two distinct types of frames that can be used in the browser 154. The first type of frames are referred to as application frames. These frames consist of pre-programmed application code such as chat rooms, webcam and authentication frames. The content and/or behavior of these frames cannot be altered dynamically. However, these frames can be fully controlled otherwise. For example, caption title font/size attributes will be passed to application code executing in these application frames. Caption keywords and tab menus attributes will be ignored. An application frame 202 containing a chat application is illustrated in FIG. 2.

The second type of frames are referred to as web browser frames. These frames, such as frames 232, 262, 282, may contain a caption bar, such as caption bars 234, 264, 284; a tab group, such as tab groups 236, 266, 286; or no content at all. The content of these frames will be determined by the frame attributes loaded at run-time from the XML template. In one preferred embodiment, the frame hierarchy will be as follows, the caption bar (if applicable) will contain clickable keywords (e.g., “Main” in the caption bar 234; “Chadster” and “Chadster ID” in the caption bar 264; and “Members” and “Search” in the caption bar 284). These keywords will either be linked to content using a Uniform Resource Identifier (URI), or a tab group located within this frame, such as a tab group ID.

If a tab group ID is specified, then the applicable tab group from within the frame should be made visible and the content area populated with appropriate content. Focus will be transferred to the tab control if applicable. If any of the tabs are clicked, then the content area will be updated using the URI pointed to in the tab attributes. This will be described in further detail herein.

In one preferred embodiment of the present invention, the caption bars are displayed above the frame using a predetermined font style and size. Tab groups are tabbed browser frames that can be integrated into the frame. When a tab group is made visible in the frame, then the default tabs content will be loaded and displayed in the content area. For example, as shown in FIG. 2, the tab group 266 under “Chadster” contains the tabs “Menu” and “My Account,” with the content of the “Menu” tab being active. Tabs may be added to a frame without using a caption-based menu.

The following is a list of frame attributes implemented by the browser 154:

FRAME_ID—(Integer) this variable identifies this frame from any other frame in the application. This ID may contain one of the pre-defined frames.

FRAME_LOCATION—(Integer) this variable controls where this form will be positioned on. All other size and location variables are based off of the frame on which this frame is located.

FRAME_TOP—(Integer) this is the vertical percentage location to anchor this frame's top line. For example a value of 5 will locate this frame's top side at 5% of the parent frame. Only values from zero (0) to one hundred (100) will be considered legal.

FRAME_LEFT—(Integer) anchors the left side of the frame window at this percentage.

FRAME_WIDTH—(Integer) the frame's width will be set to the width of the parent frame in relation to this variable. For example; if the parent frame is 100 pixels wide and this value is set to 20(%), then this frame's width will be set to 20 pixels.

FRAME_HEIGHT—(Integer) the frame's height will be set to the height of the parent frame in relation to this variable. For example; if the parent frame is 100 pixels height and this value is set to 20(%), then this frame's width will be set to 20 pixels.

FRAME_CAPTION—(Char 20) the frame's caption or title bar. This value is inserted into the captions as displayed in the GUI layout. If this value is empty then the caption should be invisible.

FRAME_CAPTION_FONT—(Char 50) the font name used in the caption text. If this font is not found on the system then the application default font shall be used.

FRAME_CAPTION_FONT_SIZE—(Integer) the size of the caption text in points. If this value is out of range then the application default font shall be used.

FRAME_VISIBLE—(Boolean) the frame's visibility state to the user. This allows the allocation and setting-up of “invisible” frames that may be displayed by a user-event later on. Any child frames will also to match the state of this variable. To maintain the previous state of child-frames, the parent should reset each child according to its initial value prior to the parent state change.

FRAME_USER_RESIZE—(Boolean) if set to TRUE then the user will be permitted to change the size of this frame. Any child frames should be notified of size changes so they can deal with them accordingly.

FRAME_CLOSE_VERT—(Boolean) if this is set to TRUE and a caption exists for this frame, then the frame will close vertically. This means the content of the frame will be invisible and the caption will auto-orient to the bottom of the parent frame in a horizontal position. If this option is FALSE then the caption will swing vertically and orient itself vertically along the LEFT side of the parent frame.

FRAME_INIT_URI—(Char 200) this string is a URI that will be saved into a property variable for this frame. If a web browser control is present, then this URI is loaded in the browser any time this frame is initialized or user-initiated “home” position.

FRAME_CAPTION_MENU—(Integer) this value points to the ID of a set of attributes for frame captions.

Pre-Defined Application Frames

FRAME_ID_APP=0. This is the application or window itself.

FRAME_ID_TAB=1. The tab frame with embedded browsers will be defined as frame zero.

FRAME_ID_USER_INFO=2. Frame one (1) will be reserved for the user information frame. This application specific frame will show status information (e.g., frame 216 in FIG. 2).

FRAME_ID_CHAT_SESSION=3. Chat main frame (e.g., the chat frame 202). The three chat frames will reside in this super frame.

FRAME_ID_CHAT_ROOMS=4. Chat room list pane (e.g., frame 212 in FIG. 2).

FRAME_ID_CHAT_CURRENT=5. Public and private chat rooms in which the user is engaged (e.g., frame 214 in FIG. 2).

FRAME_ID_CHAT_CHATS=6. This frame contains the session in which the user is engaged.

FRAME_ID_WEBCAM=7. Webcam application.

FRAME_ID_FILEBOX=8. File Box frame.

FRAME_ID_LOGIN=9. Although this is a web browser frame, it will contain custom code for intercepting the document for use with authentication.

FRAME_ID_BROWSER=25. Generic browser frames begin from this Index. Any frame with an ID below 25 is considered to be application-based.

In one preferred embodiment of the present invention, the resizing of frames will be limited to the size of the parent frame and only vertical scroll bars are allowed. The closing of a frame will be allowed if the frame caption bar is made visible. When a frame is in a closed state, its contents will be invisible and its caption bar will remain visible and orient itself at the bottom of the parent frame. This closing will allow bordering child frames to automatically expand proportionately—taking up the space. When a frame is made visible again then the opposite should take place, where the frame will grow to its original size and the child frames will also return to its original position—overriding any changes in size to the other child frames since the hide/close event.

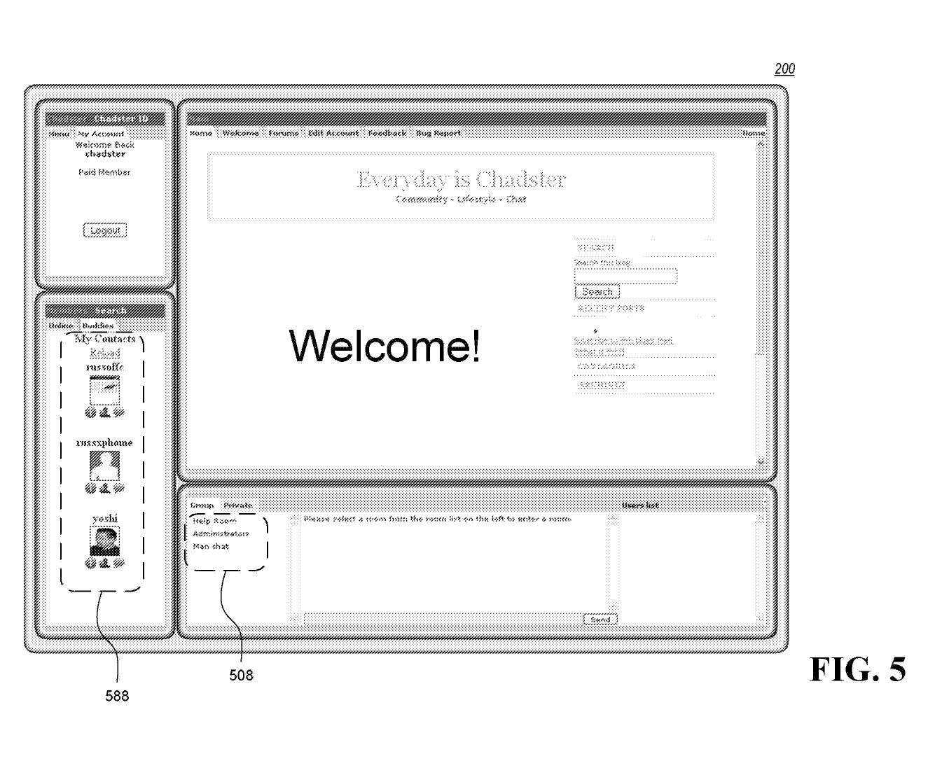

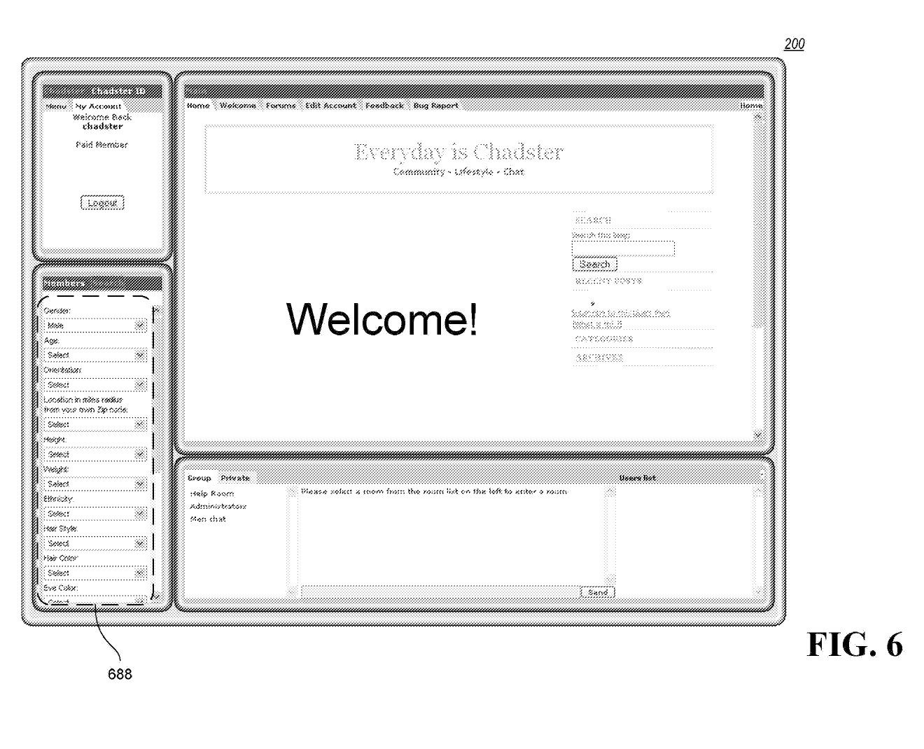

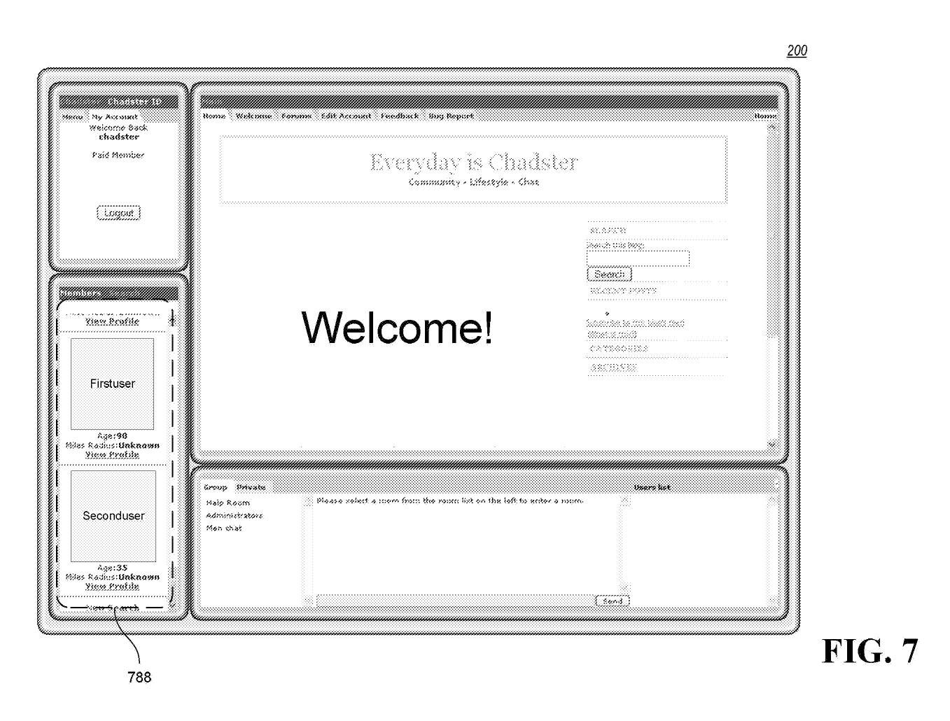

One of the features of system 100 is to allow users of the system to locate other users with similar interest and allow them to communicate with each other through the various communication modalities offered by the system 100. There are various ways that the user can locate other users of interest using the system 100. Firstly, the user can quickly locate the user's friends by using an address book, as shown in the content area 588 in FIG. 5. The system 100 also allows the user to find other users using searches. FIG. 6 is a screen capture of GUI 200 showing a search feature in content area 688, where the user can search for another user with particular criteria. FIG. 7 is a screen capture of GUI 200 showing the results of the search in content area 788.

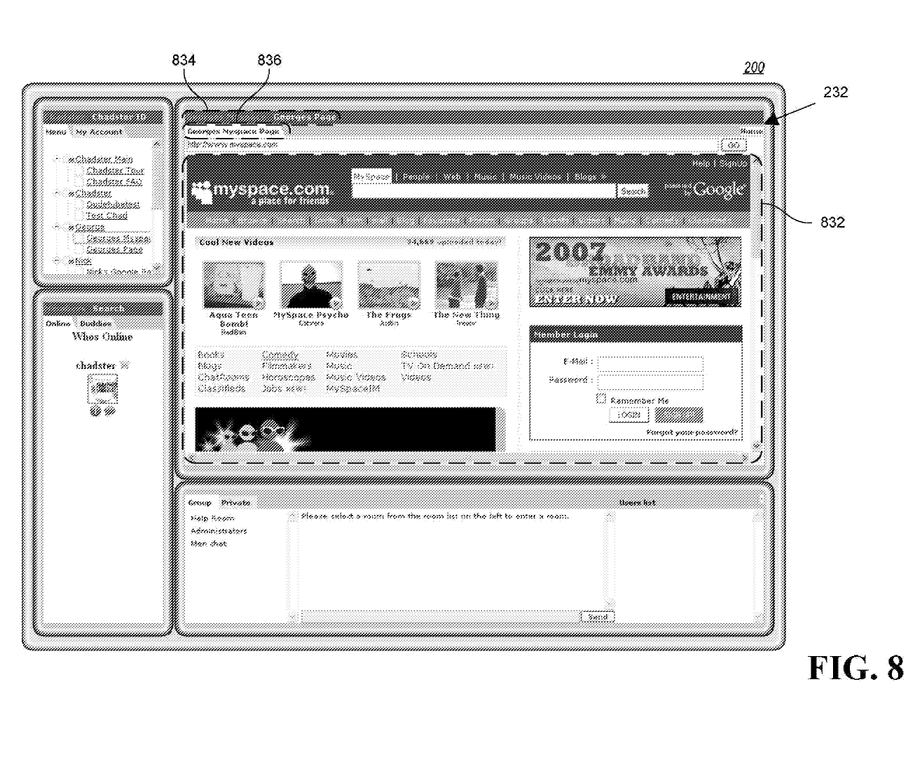

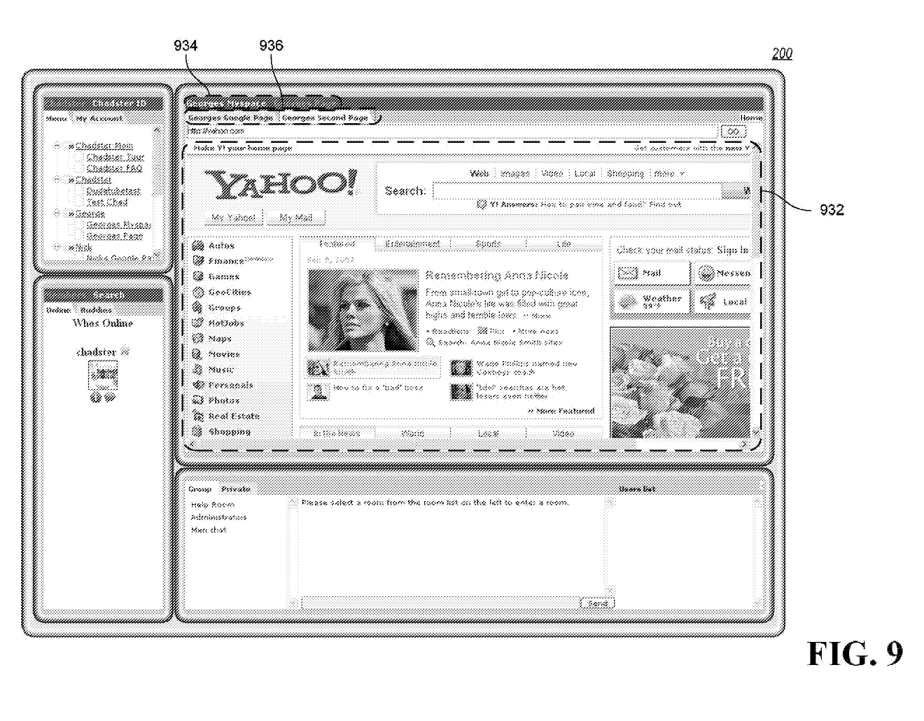

The system 100 also provides for the creation of a multi-tabbed browsing system in a compact interface that is combined with the other features, such as chat, IM, etc. FIG. 8 illustrates the display of a web page in a content area 832 from a tab “Georges Myspace Page” in a group of tabs 836 under a “Georges Myspace” keyword in a caption bar 834. When the user clicks on a “Georges Page” keyword in the caption bar 934, as illustrated in FIG. 9, a group of tabs 936 is displayed. In the figure, the “Georges Second Page” tab is selected, which loads the web page from yahoo.com in the content area 932.

In addition to configuring the system 100 to access and navigate multiple sites, the system 100 can also allow the content of a complex site to be rearranged so it can be presented to the user within two navigational clicks by the user. For example, a site like E-bay could place the buy and sell web page in one frame and the “My E-Bay” section in another frame. This would allow simultaneous access to these features by the user. The implementation of these custom layouts is achieved through the use of a partner ID, which is further discussed below.

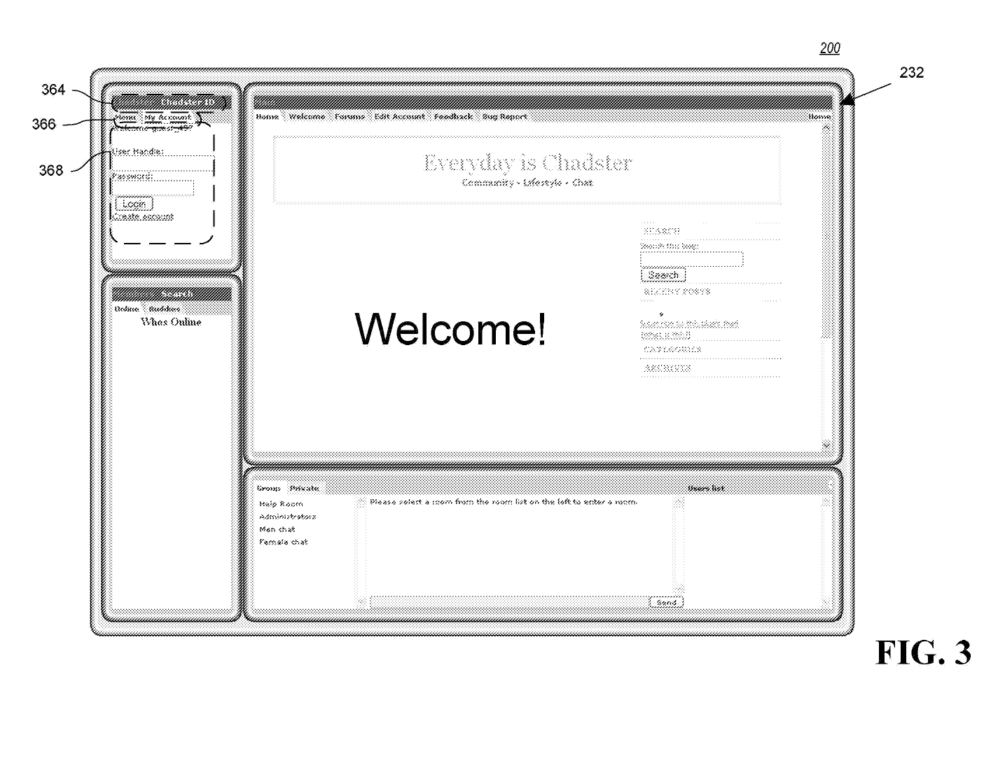

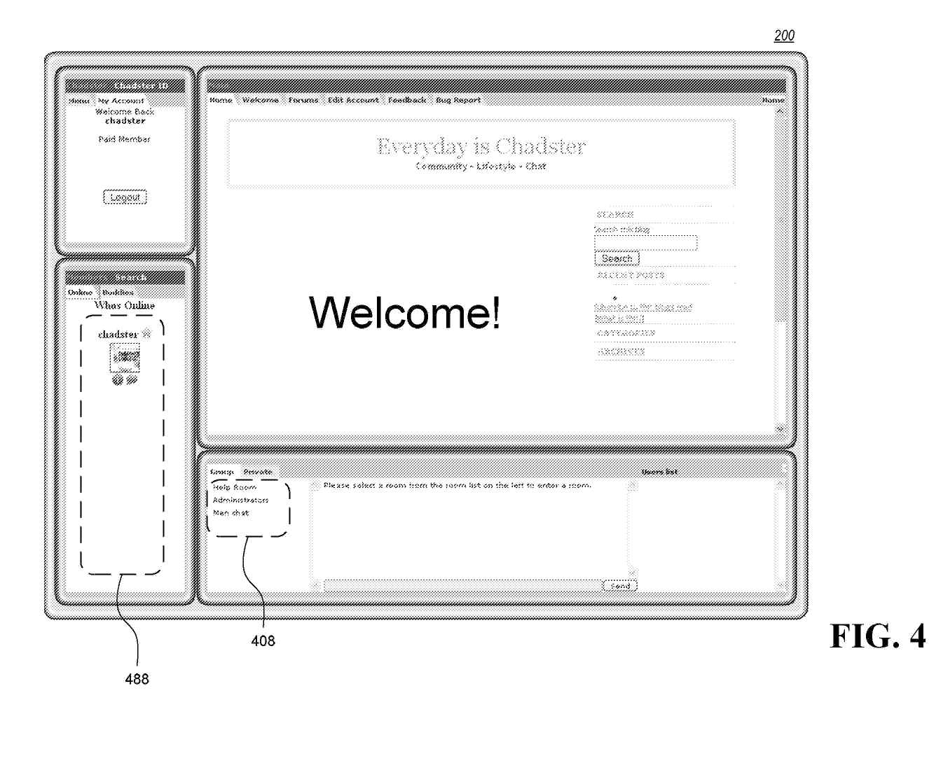

FIGS. 3 and 4 illustrates the authentication process by the user. In FIG. 3, the user has selected the “My Account” tab in tab group 366, and is ready to login by supplying a User Handle and Password the content area 368. In FIG. 4, once the user has successfully logged in, the GUI 200 is altered to reflect that the user is a “Paid Member,” and a content area 488 is updated to reflect who is currently logged into the system (i.e., online). Further, the GUI 200 is updated based on the preferences of the user. For example, the group chat list in the content area 408 is altered such that the “Female Chat” entry has been removed.

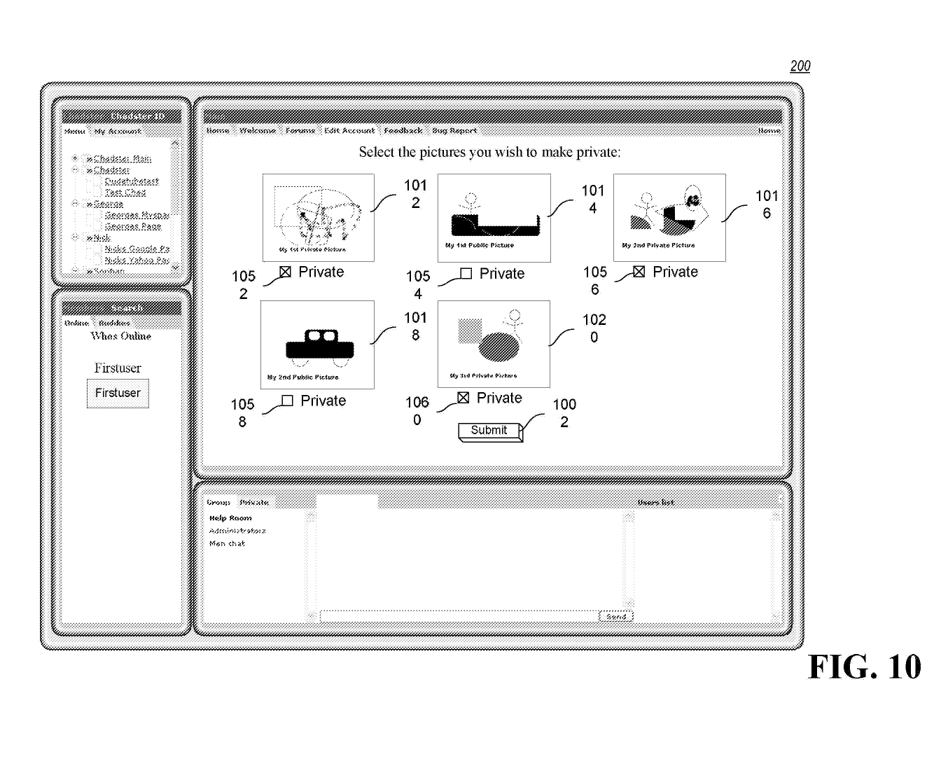

In one preferred embodiment of the present invention, the system 100 allows users to restrict access to certain parts of the user's account, such as the user's pictures. Referring to FIG. 10, the user may designate certain pictures as being “Private,” and thereby restricting access to those pictures. For example, the user has restricted access to pictures 1012, 1016 and 1020 from all of the user's pictures 1012, 1014, 1016, 1018, and 1020 by selecting checkboxes 1052, 1056 and 1060 while leaving pictures 1014 and 1018 as being unrestricted by not selecting checkboxes 1054 and 1058. The user can save the designations by clicking on a “Submit” button 1002, which will store the designations in database 126 on database server 106.

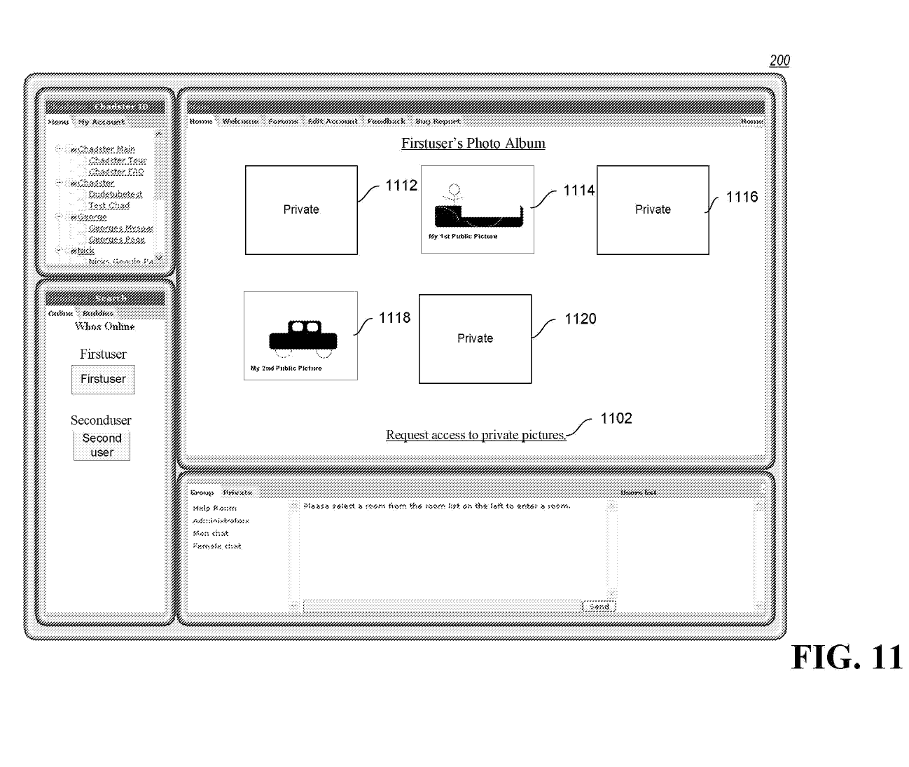

In FIG. 11, another, second user requests access to the private pictures of the user displayed as “Private” pictures 1112, 1116, and 1118 by sending a request to the user. In one embodiment, the second user clicks on a “Request access to private pictures.” Link to send the request. In other preferred embodiments of the present invention, the pictures which have been made private may not be displayed so that the second user will not know how many private pictures there are for the user.

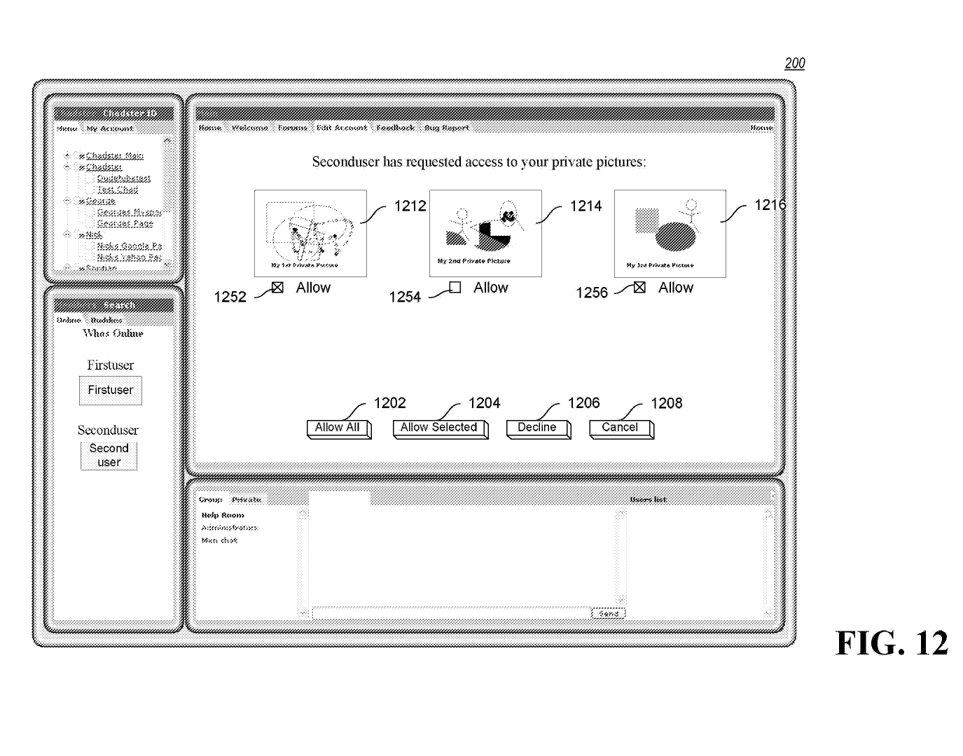

In FIG. 12, the user can allow the second user access to the pictures the user has previously made private by selecting checkboxes 1252, 1254 and/or 1256. In addition, the user can allow the second user to: access all the private pictures by clicking on a “Allow All” button 1202; access only the pictures the user has chosen to allow the second user to access (e.g., pictures 1212, 1216) by first selecting checkboxes 1252, 1256 and then clicking on the “Allow Selected” button 1204; decline the request from the second user to access any of the private pictures of the user by clicking on the “Decline” button 1206; or navigate away from this page to make a decision later by clicking on a “Cancel” button 1208. In this example, the user has chosen to allow the second user to access pictures 1212, 1216. In one preferred embodiment, the access rights assigned to the second user for the private pictures of the user are stored in the database 126. These rights are later queried when the second user requests the viewing of the user's pictures.

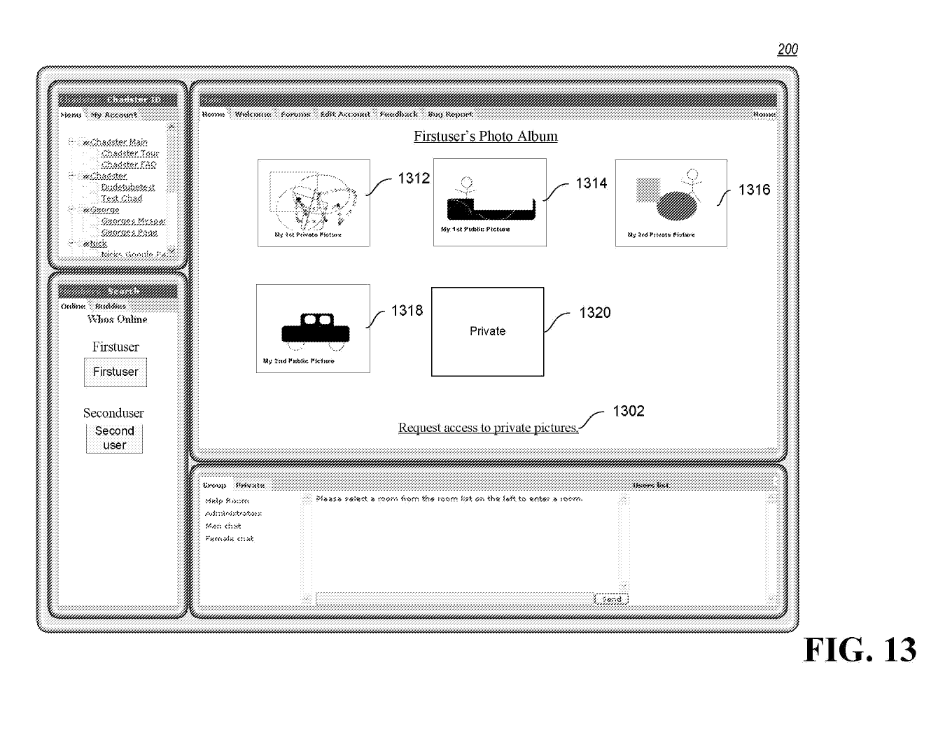

In FIG. 13, the second user is now able to access pictures 1312 and 1316, which were previously made private, and those pictures are displayed. A “Request access to private pictures.” Link 1302 is still displayed because the user still has a picture 1320 to which the user has not granted the second user access. Thus, the second user may send another request to have the user allow the second user access the photos.

Referring back to FIG. 2 and also FIGS. 4, 5, 14 and 15, the chat functionality provided by the system 100 will now be discussed. In one preferred embodiment of the present invention, the chat application can provide services such as chat rooms, instant messaging, webcam and file transfer. The chat application, as well as other applications, are modules that will allow the clients to be customized and to have features added for a specific purpose, such as video-on-demand or presenting Java/Flash content via dynamic browser frames located in the application. The chat application may be implanted as part of the applet 156 or another, stand-alone applet. Further, in one preferred embodiment of the present invention, the chat application will communicate all chat messaging data directly with the chat server 104 (or, in the case where the proxy server is a part of the implementation, directly with the proxy server 108), thereby bypassing the need to involve the web server 102 for anything other than the administrative aspects of the chat application, as described herein.

The chat application will allow users to access a real-time chat community.

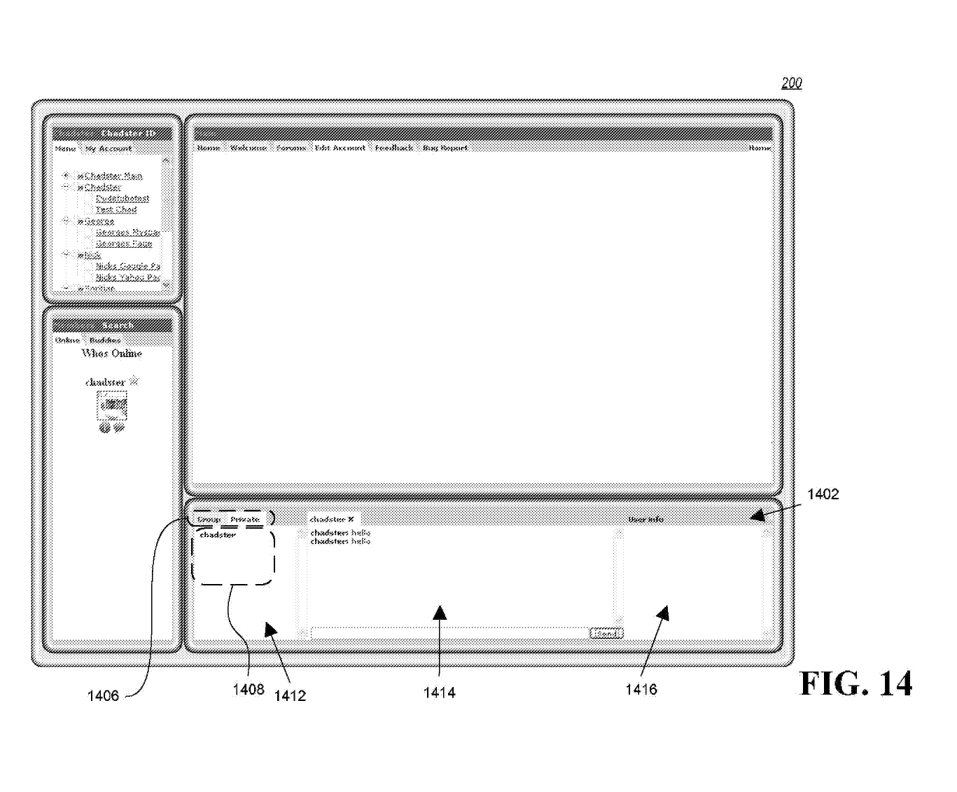

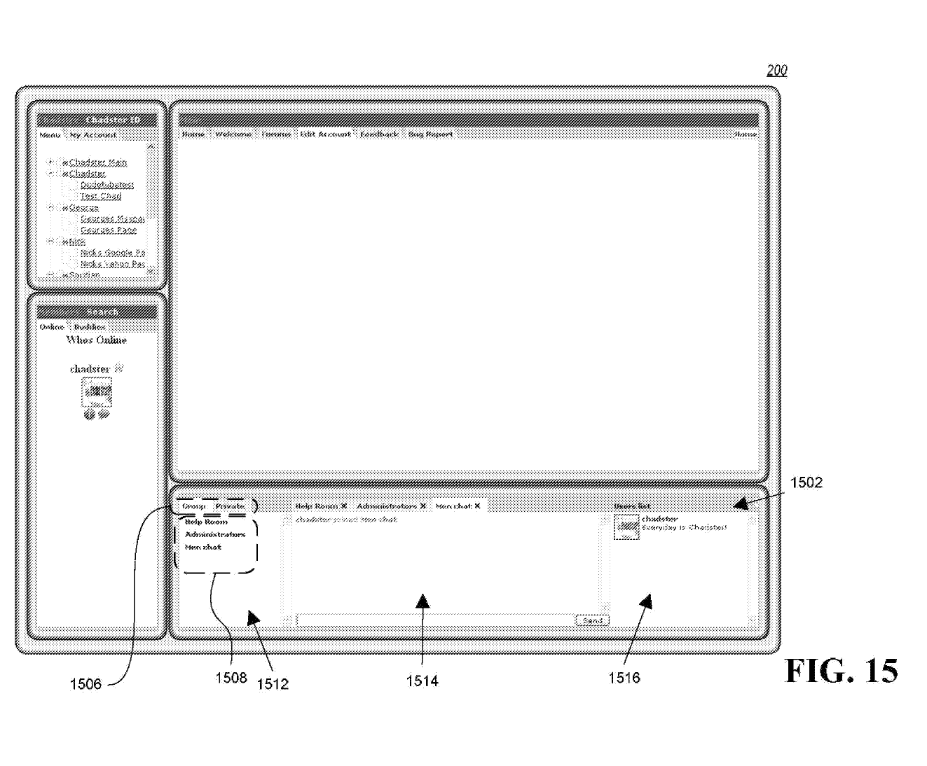

The chat application will comprise features such as a buddy list (e.g., content area 588 in FIG. 5), ignore list, group chat rooms (e.g., content area 508 in FIG. 5), private (i.e., one-on-one) chat rooms (e.g., content area 1408 in FIG. 14) and online/offline notification of buddies (e.g., content area 488 in FIG. 4). Although these features are built-in, they may also be customizable so that a website designer may choose to inhibit or hide certain features. For example, a website designer may want the instant-messaging component but may elect to add/remove specific entries in the group room chat list or remove the group room chat feature altogether. As shown in FIG. 2, GUI 200 includes a content area 208 in the chat frame 212 that shows a list of group chat rooms, a frame 214 that displays chat messages; and a user list frame 216 that displays the users participating in the chat room. FIG. 15 is a view of the GUI 200 after the user has logged into the system 100, where the content area 208 has been updated with a list of rooms customized to be displayed for the user, as shown by a content area 1508.

Preferably, the system 100 will support millions of users with a subset of them concurrently using it at any particular instant. In one preferred embodiment of the present invention, to facilitate the handling of this volume of traffic, many of the features provided by the system 100 will be invoked using scripts that will be called from the first client 152 via a Uniform Resource Identifier (URI). The use of scripting and the URI's allows for maximum customization of the implementation of the functionality provided by the system 100 in that each type of task can be allocated to servers specifically optimized to handle that type of task. As applied to the chat application, the use of scripts and URI's reduces the load on the real-time services handled by the chat server 104 by offloading many of the administrative aspects of supporting the chat application to other servers.

For example, the modification to a user's buddy list is an operation that is related to the administrative aspects of the chat application and involves the updating of the database 126 on the database server 106, which is optimized to handle these type of operations. In one preferred embodiment of the present invention, the web server 102 is used to coordinate the request and interface with the database server 106. Thus, when the user wants to modify the user's buddy list, the request is transmitted to the web server 102, which then will update the database 126 that is contained in the database server 106.

Specifically, the first client 152 will make a call using a URI, which in this case is a request sent to the web server 102 to execute a PHP: Hypertext Preprocessor (PHP) script on the web server 102 to update the database 126. The workload for updating the user's contact list will be transferred to the web server 102 through the use of a scriptable method, which in this case is a scriptable database method. This method and other database related methods can also implemented using scripting language technology such as Active Server Pages (ASP) technology and designed to perform core functions against the database 126 contained in the database server 106.

An exemplary URI for updating a “buddy list” to add a “buddy” is presented as follows:

http://client.webserver.com/memberscripts/modcontacts.php?function=addbuddy&co ntact=yoshi

where “modcontacts.php” is the PHP script that is executed on the web server 102 (e.g., “client.webserver.com”), and “yoshi” is the contact to be added using the function “addbuddy”.

In one preferred embodiment, the configuration file for the client will include this code:

Memberscripts.addbuddy=http://client.webserver.com/memberscripts/modcontacts.php?function=addbuddy&contact=%TARGET%

where the “%TARGET%” is a variable placeholder.

The scripting approach provides easy and flexible integration of the clients into third-party computing environments and networks as the methods are triggered via standard HTTP calls. Also, in one preferred embodiment of the present invention, all frames in the browser share the same HTTP session. Thus, even if an event takes place in one frame, a simple refresh will re-synchronize the sessions in other browser frames.

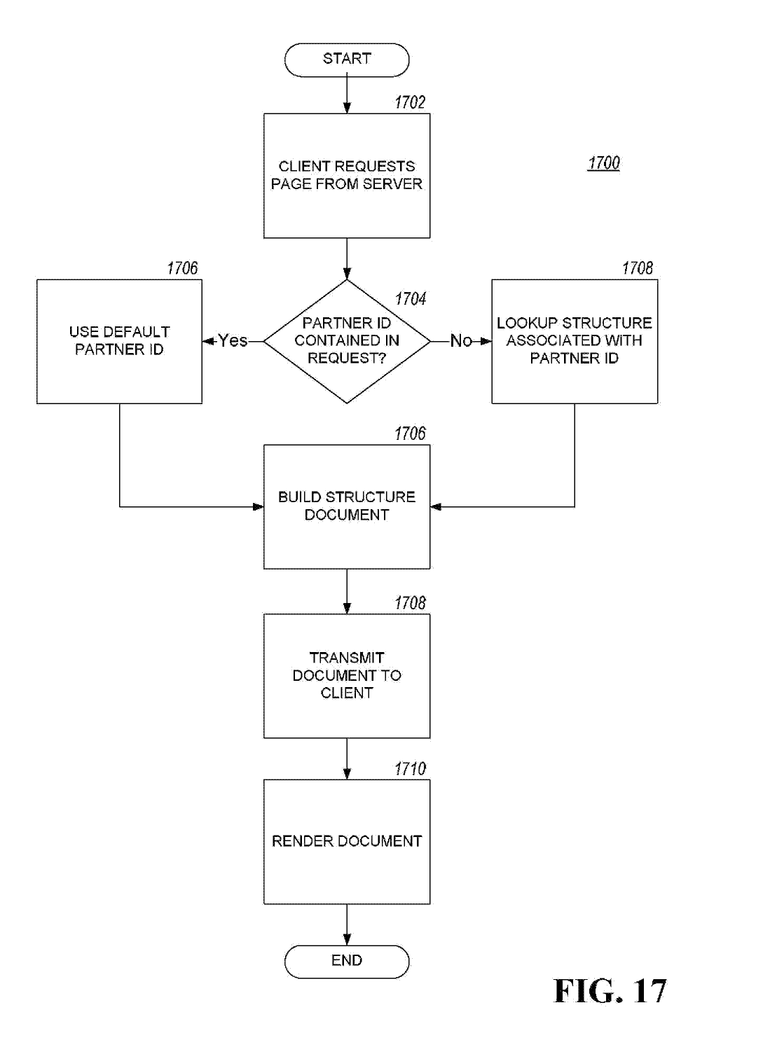

The initialization and operation of the system 100 in accordance with one preferred mode is now discussed with reference to FIG. 17 where, in step 1702, the first client 152 requests an initial page from the web server 102, which is the “home page.” Specifically, the user will launch the browser 154, which will access the home page of the website stored on web server 102. In one preferred embodiment of the present invention, the web server 102 will transmit the applet 156 to the browser 154 along with the initial page. As discussed previously, the initial page will contain a URI for the first client 152 to download the configuration template (i.e., the XML document). Thus, the browser 154 will initially request the home page, which will contain the applet 156 and a URI to retrieve the configuration template. Once the applet 156 has been downloaded, it will begin to execute and will request the configuration template from the web server 102.

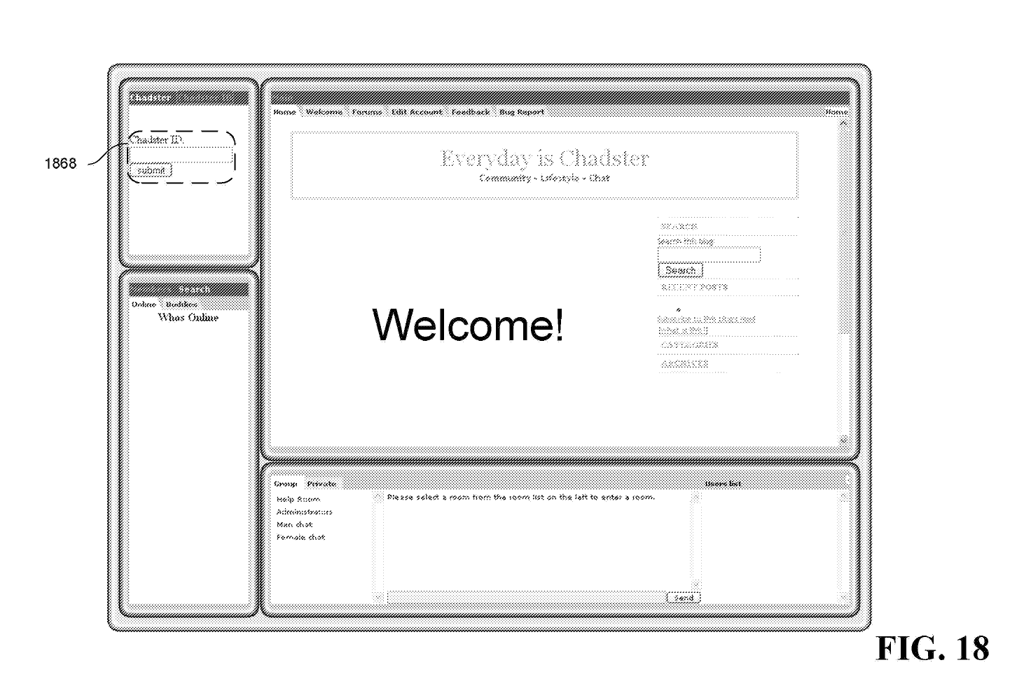

In step 1704, the web server 102 receives the request to download the configuration template from the applet 156 and will determined if a partner ID is contained in the request. As further described below, the use of an identification such as the partner ID allows the customization of the GUI 200 based on stored layout definitions or preferences. Although the description of the user of the partner ID herein is applied to a company, there should be no limitations or restrictions as to applying partner ID's for individual users. In addition, the present invention contemplates the use of multiple ID's in the customization of the configuration template and the GUI 200. As illustrated in FIG. 18, the user can also enter a partner ID in an entry field 1868 labeled (“Chadster ID”) to retrieve a layout specific for the partner ID.

If no partner ID is contained in the request, then operation continues with step 1706, where a default partner ID is used and operation continues with step 1708 as if a partner ID is passed from the first client 152, except the partner ID is the default partner ID. If a partner ID is contained in the request, operation will continue with step 1708.

In step 1708, where the web server 102 will create a configuration template customized based on the received partner ID. In one preferred embodiment of the present invention, the web sever 102 executes a script to build the configuration template.

Specifically, the web sever 102 executes a PHP script that interactively fetches, based on the partner ID, the description of caption bars, menu entries and/or tab groups to be created on GUI 200 from the database 126 on the database server 106. Thus, execution of the PHP script by the web sever 102 will result in the building of a unique configuration template based on the specific partner ID for GUI 200. In addition to adding custom caption bars, menu entries and tabs based on the partner ID, the PHP script will also insert references to content (e.g., URLs and URIs) in the configuration template based on the partner ID. For example, a partner may wish to include a tab that displays a home page for their website, as well as tabs for other sites of interest.

In addition to building the configuration template based on the partner ID, the configuration template may also be modified based on other criteria or parameters. For example, the created configuration template may change based on the time of day, as well as the locale from where the request is coming. Thus, where the configuration template is being generated for a television network (i.e., the television network is the partner), the television network may want to alter the configuration template to include content specifically targeted towards daytime, evening, and/late night audiences. Another example would be the creation of the configuration template based on variables retrieved from an external source, such as querying a partner or third party for status information of their website before inserted a reference to their content.

Further, where it is desirable to use multiple versions of PHP scripts, the choice of the PHP script that is used to generate the configuration template may also be based on any of the aforementioned criteria. Further still, both the script and the configuration template can include reference calls to retrieve code or file segments that are to be inserted into the script and/or configuration template before the script or configuration template is executed and/or parsed, respectively. For example, as shown by the code attached hereto as Appendix I, the entirety of which is incorporated herein by reference, the generated configuration document (i.e., the XML file named “config.xml”) includes the instruction:

<include href=“chadsmall.xml”>
</include>

which in one preferred embodiment of the present invention, will cause the applet 156 to include the contents of the file “chadsmall.xml” into config.xml before the applet 156 parses config.xml to render the GUI 200. A copy of chadsmall.xml is attached hereto as Appendix II, and the entirety of which is incorporated herein by reference.

It should be noted that, in this example, no path is given for the location of the include file (i.e., chadsmall.xml), which means that the include file is located in the same directory as the parent XML file (i.e., config.xml). However, as the include command utilizes the URI syntax, the include file may be located in another location, including another server. For example, if the include file is located on a server “aserver.com”, then the instruction would read:

<include href=“http://aserver.com/chadsmall.xml”>
</include>

which would cause the applet 156 to retrieve the file “chadsmall.xml” from the HTTP server at aserver.com.

In addition, although the example provided herein is directed towards the inclusion of additional elements, it is noted that the system 100 also contemplates being able to remove elements from the layout as it is being dynamically updated. Thus, for example, the applet 156 can eliminate components when it re-renders the layout.

In step 1708, once the configuration template has been generated, it will be transmitted to the first client 152. Then, in step 1710, the configuration template will be read by the applet 156 and any include files will be retrieved before the applet 156 renders the GUI 200. In one preferred embodiment of the present invention, all content associated with the user interface elements is retrieved when the GUI 200 is rendered. In another preferred embodiment, the calls to retrieve the content are not made until the user actually selects the tab or menu item in question.

In one preferred embodiment of the present invention, again referring to FIG. 2, a list of content sources that may be selected by the user is included in a content portion 268. The content source can be associated with a partner. When a user selects one of the entries in the list of content sources, the applet 156 will retrieve the configuration template associated with that entry using an URI. In the example as shown in FIG. 8, the applet 156 has downloaded the XML document associated with the “George” entry as listed in the list of content sources and updated the GUI 200 to re-ender the frame 232 with a new set of menus and tabs, as well as content that is downloaded from content sources specified by the partner in the XML document. In this fashion, only the portions of the GUI 200 that need to be changed will be changed, without the need to change the complete interface by downloading a new web page. Thus, the layout and interface may be loaded and adjusted dynamically as it is being used.

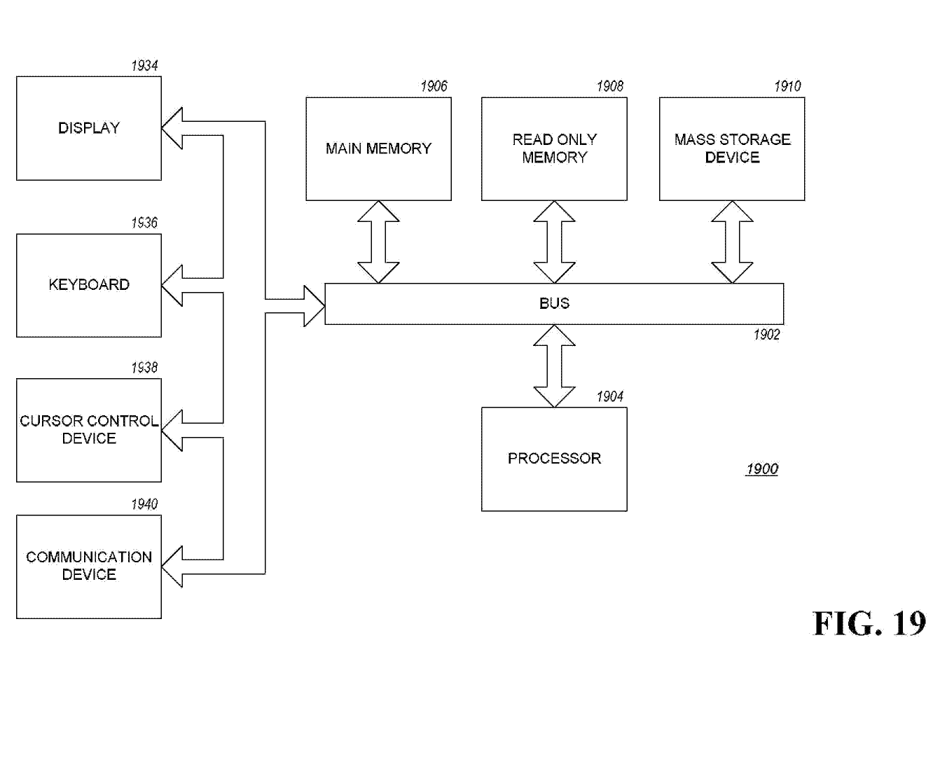

FIG. 19 illustrates an example of a computer system 1900 in which the features of the present invention may be implemented. The computer system 1900 includes a bus 1902 for communicating information between the components in the computer system 1900, and a processor 1904 coupled with the bus 1902 for executing software code, or instructions, and processing information. The computer system 1900 further comprises a main memory 1906, which may be implemented using random access memory (RAM) and/or other random memory storage device, coupled to the bus 1902 for storing information and instructions to be executed by the processor 1904. The main memory 1906 also may be used for storing temporary variables or other intermediate information during execution of instructions by the processor 1904. The computer system 1900 also includes a read only memory (ROM) 1908 and/or other static storage device coupled to the bus 1902 for storing static information and instructions for the processor 1904.

Further, a mass storage device 1910, such as a magnetic disk drive and/or a optical disk drive, may be coupled to the computer system 1900 for storing information and instructions. The computer system 1900 can also be coupled via the bus 1902 to a display device 1934, such as a cathode ray tube (CRT) display or a liquid crystal display (LCD) display, for displaying information to a user so that, for example, graphical or textual information may be presented to the user on the display device 1934. Typically, an alphanumeric input device 1936, that includes alphanumeric and other keys, is coupled to the bus 1902 for communicating information and/or user commands to the processor 1904. Another type of user input device shown in the figure is a cursor control device 1938, such as a conventional computer mouse, trackball, track pad or other type of cursor direction control for communicating both direction information for controlling the movement of a cursor on the display 1934 and command selection to the processor 1904. Thus, various types of input devices including, but not limited to, the input devices as described herein allow the user to provide command or input to the computer system 1900. For example, in the description contained herein, reference may be made to the user “selecting,” “clicking,” or “inputting,” or any grammatical variations thereof, one or more items in a user interface. These should be understood to mean that the user is using one or more input devices to accomplish the input. Although not illustrated, the computer system 1900 may optionally include such devices as a video camera, speakers, a sound card, or many other conventional computer peripheral options.

A communication device 1940 is also coupled to the bus 1902 for communicating with other computing devices, as described herein. The communication device 1940 may include a modem, a network interface card, or other well-known interface devices, such as those used for interfacing with Ethernet, Token-ring, or other types of networks. In this manner, the computer system 1900 may be coupled to a number of other computer systems and/or computing devices.

It should be noted that the methods described herein may be implemented on a variety of communication hardware, processors and systems known by one of ordinary skill in the art. For example, the general requirement for the client to operate as described herein is that the client has a display to display content and information, a processor to control the operation of the client and a memory for storing data and programs related to the operation of the client. The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments without departing from the spirit or scope of the novel aspects described herein. Thus, the scope of the invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as the most preferred or advantageous over other embodiments. Accordingly, the present invention is to be defined solely by the scope of the following claims.

APPENDIX I
SAMPLE XML CONFIGURATION TEMPLATE - “config.xml”

```
    <?xml version=“1.0” encoding=“utf-8” ?>
    <layouts>
      <layout id=“chadster” cssText=“text-align: center; margin:
0px; background-color: black; padding-top: 2px;”>
        <screen id=“main_frame” cssText=“border:2px solid #A8C8F8;
text-align: left; vertical-align: top; height: 100%;”
align=“center”>
          <frame cssText=“margin-bottom: 3px; background-color:
#A8C8F8” id=“login_frame” width=“169” height=“232”>
            <parenttabcontrol id=“login_ptab”
divid=“login_ptabCont”>
              <tabpage id=“login_tabpage” caption=“Chadster”
bgcolor=“A8C8F8” tabborder=“1” tabbordercolor=“F80888”
tabcontentborder=“1” tabcontentbordercolor=“0868F8”>
                <tabcontrol id=“login_tab” divid=“login_tabCont” >
                  <tabpage id=“main_menu_tabpage”
                  caption=“Menu”>
<browser id=“main_menu_page”
href=“mainmenu.htm” scrolling=“no” class=“LeftIframeStyle”
cssText=“background-color:White;” width=“169” height=“193” />
                  </tabpage>
                  <tabpage id=“login_authorize_tabpage”
caption=“My Account”>
                    <browser id=“authorize_page”
href=“/community/login.php” scrolling=“no” class=“LeftIframeStyle”
cssText=“background-color:White;” width=“169” height=“193” />
                  </tabpage>
                </tabcontrol>
              </tabpage>
              <tabpage id=“chadid_tabpage” caption=“Chadster ID”
bgcolor=“A8C8F8” tabborder=“1” tabbordercolor=“F80888”
tabcontentborder=“1” tabcontentbordercolor=“0868F8”>
            <browser id=“chadid_authorize_page”
href=“/app/bounceto.php” scrolling=“no” class=“LeftIframeStyle”
cssText=“background-color:White;” width=“169” height=“210” />
              </tabpage>
            </parenttabcontrol>
          </frame>
          <frame cssText=“border:0px solid #00FC02; background-
color: #A8C8F8; margin:0px;” border=“1” id=“member_frame”
width=“169” height=“455” >
            <parenttabcontrol id=“member_ptab”
divid=“member_ptabCont”>
              <tabpage id=“member_tabpage” caption=“Members”
bgcolor=“A8C8F8”>
                <tabcontrol id=“member_tab”
                divid=“member_tabCont”>
                  <tabpage id=“member_online_tabpage”
caption=“Online”>
                    <browser id=“member_online_page”
href=“/app/test_content/memberonline.php” scrolling=“no”
class=“LeftIframeStyle” cssText=“background-color:White;”
width=“169” height=“416” />
                  </tabpage>
                  <tabpage id=“member_buddies_tabpage”
caption=“Buddies”>
                    <browser id=“member_buddies_page”
href=“/app/test_content/contactlist.php?mode=buddy” scrolling=“no”
class=“LeftIframeStyle” cssText=“background-color:White;”
width=“169” height=“416” />
                  </tabpage>
                </tabcontrol>
              </tabpage>
              <tabpage id=“powersearch_tabpage” caption=“Search”
bgcolor=“A8C8F8”>
                <browser id=“powersearch_search_page”
href=“/community/search.php” scrolling=“no”
class=“LeftIframeStyle” cssText=“background-color:White;”
width=“169” height=“432” />
            </tabpage>
            </parenttabcontrol>
          </frame>
          <include href=“chadsmall.xml”>
          </include>
          <frame cssText=“border:0px solid #787874; margin-top:
3px;” border=“1” id=“chat_frame” width=“820” height=“182”
btnColExp=“true” cssColExp=“WIDTH: 100px; height: 15px; position:
relative;left:720px; text-align: right; margin: 0px 0px −15px 0px;
padding:0px” heightColExp=“20px” adjacentColExp=“chadster_frame”
srcOpenColExp=“images/norgie_open_dna.gif”
srcClosedColExp=“images/norgie_closed_dna.gif”
altColExp=“Expand/Collapse frame” typeColExp=“text”
expandTextColExp=“+” collapseTextColExp=“−” cssTextColExp=“font-
weight: bold; font-size: x-small; text-decoration: none; font-
family: Verdana;”>
            <browser id=“chat_page” class=“chatStyle”
href=“/app/test_content/chat/chat.php” cssText=“vertical-align:
top; background-color: White; margin:0px;” width=“820”
height=“182” scrolling=“no” />
          </frame>
        </screen>
      </layout>
    </layouts>
```

APPENDIX II
INSERT TO SAMPLE XML CONFIGURATION TEMPLATE -
“chadsmall.xml”

```
  <?xml version=“1.0” encoding=“utf-8” ?>
  <frames>
      <frame cssText=“background-color: #A8C8F8; margin-
bottom: 0px; padding-bottom: 0px;” border=“1” bordercolor=“00FC02”
id=“chadster_frame” width=“820” height=“505” display=“inline”>
        <parenttabcontrol id=“chadster_ptab”
divid=“chadster_ptabCont”>
          <tabpage id=“chadsterptab_main_page” caption=“Main”>
            <tabcontrol id=“main_tab” divid=“main_tabCont”
btnHome=“true” srcHome=“images/home.gif” altHome=“Home”
typeHome=“text” cssTextHome=“margin-right:1px; font-weight: bold;
font-size: x-small; text-decoration: none; font-family: Verdana;”
>
              <tabpage id=“cd_tabpage” caption=“Chadster”>
                <browser id=“cd_page” scrolling=“yes”
href=“http://www.chadster.com/data/chadster.html”
cssText=“background-color:White; margin: 0px;” width=“820”
height=“467” />
              </tabpage>
              <tabpage id=“chadster_tabpage” caption=“Forums”>
                <browser id=“chadster_page” scrolling=“yes”
href=“http://www.chadster.com/forums/portal.php”
cssText=“background-color:White; margin: 0px;” width=“820”
height=“467” />
              </tabpage>
              <tabpage id=“chadster_maintab_basic”
caption=“Edit Account”>
                <browser id=“chadster_maintab_pagebasic”
scrolling=“yes”
href=“http://vod.chadster.com/community/edit_basic.php”
cssText=“background-color:White; margin: 0px;” width=“820”
height=“467” />
              </tabpage>
            </tabcontrol>
          </tabpage>
        </parenttabcontrol>
      </frame>
  </frames>
```

What is claimed is:

1. A system comprising:
a computer network;
a server computer; and,
a client computer coupled to the server computer through the computer network, the client computer having a browser software executing thereon implementing a method of presenting multi-dimensional content in the client computer, the method comprising:
transmitting an identifier;
receiving a hierarchical document generated based on the identifier; and,
rendering a graphical user interface (GUI) based on the hierarchical document.

2. The system of claim 1, wherein the hierarchical document comprises an extensible markup language code document.

3. The system of claim 1, wherein receiving the hierarchical document generated based on the identifier comprises:
performing a lookup to a database based on the identifier; and,
retrieving a set of customizations related to the identifier.

4. The system of claim 1, wherein the hierarchical document comprises a plurality of GUI elements and a layout description for the plurality of GUI elements.

5. The system of claim 4, wherein the rendering of the GUI based on the hierarchical document comprises:
parsing the hierarchical document to retrieve the layout description and the plurality of GUI elements; and,
rendering the plurality of GUI elements based on the layout description.

6. The system of claim 4, wherein the method implemented by the browser further comprising:
receiving a user interaction with the plurality of GUI elements; and,
re-rendering the GUI based on the user interaction and the layout description of the plurality of GUI elements.

7. The system of claim 4, wherein the plurality of GUI elements comprises at least one caption bar and at least one tab element.

8. The system of claim 4, wherein the layout comprises at least one frame definition.

9. The system of claim 1, wherein the hierarchical document comprises a reference to a child document having a plurality of GUI elements and a layout description and wherein the method further comprising:
retrieving the child document; and,
integrating the child document with the hierarchical document.

10. A method for presenting multi-dimensional content in a client, the method comprising:
transmitting an identifier;
receiving a hierarchical document generated based on the identifier; and,
rendering a graphical user interface (GUI) based on the hierarchical document.

11. The method of claim 10, wherein the hierarchical document comprises an extensible markup language code document.

12. The method of claim 10, wherein receiving the hierarchical document generated based on the identifier comprises:
performing a lookup to a database based on the identifier;
retrieving a set of customizations related to the identifier;

13. The method of claim 10, wherein the hierarchical document comprises a plurality of GUI elements and a layout description for the plurality of GUI elements.

14. The method of claim 13, wherein the rendering of the GUI based on the hierarchical document comprises:
parsing the hierarchical document to retrieve the layout description and the plurality of GUI elements; and,
rendering the plurality of GUI elements based on the layout description.

15. The method of claim 13, further comprising:
receiving a user interaction with the plurality of GUI elements; and,
re-rendering the GUI based on the user interaction and the layout description for the plurality of GUI elements.

16. The method of claim 13, wherein the plurality of GUI elements comprises at least one caption bar and at least one tab element.

17. The method of claim 13, wherein the layout comprises at least one frame definition.

18. The method of claim 10, wherein the hierarchical document comprises a reference to a child document having a plurality of GUI elements and a layout description, the method further comprising:
retrieving the child document; and,
integrating the child document with the hierarchical document.

19. A computer readable medium comprising computer-executable code that, when executed, implements a method of presenting multi-dimensional content in a client, the method comprising:
transmitting an identifier;
receiving a hierarchical document generated based on the identifier; and,
rendering of a graphical user interface (GUI) based on the hierarchical document.

20. The computer readable medium of claim 19, wherein the hierarchical document comprises an extensible markup language code document.

21. The computer readable medium of claim 19, wherein receiving the hierarchical document generated based on the identifier comprises:
performing a lookup to a database based on the identifier; and,
retrieving a set of customizations related to the identifier.

22. The computer readable medium of claim 19, wherein the hierarchical document comprises a plurality of GUI elements and a layout description for the plurality of GUI elements.

23. The computer readable medium of claim 22, wherein the rendering of the GUI based on the hierarchical document comprises:
parsing the hierarchical document to retrieve the layout description and the plurality of GUI elements; and,
rendering the plurality of GUI elements based on the layout description.

24. The computer readable medium of claim 22, wherein the method further comprising:
receiving a user interaction with the plurality of GUI elements; and,
re-rendering the GUI based on the user interaction and the layout description of the plurality of GUI elements.

25. The computer readable medium of claim 22, wherein the plurality of GUI elements comprises at least one caption bar and at least one tab element.

26. The computer readable medium of claim 22, wherein the layout comprises at least one frame definition.

27. The computer readable medium of claim 19, wherein the hierarchical document comprises a reference to a child document having a plurality of GUI elements and a layout description and wherein the method further comprising:
retrieving the child document; and,
integrating the child document with the hierarchical document.

28. A system for a first user to manage access, by a second user, of a plurality of restricted access images stored on a server computer, the server computer comprising computer readable medium having computer executable code that, when executed, implements a method comprising:
receiving, from the second user, an access request to access the plurality of restricted access images stored on the server computer;
presenting, to the first user, the request from the second user to access the plurality of restricted access images stored on the server computer;
receiving, from the first user, a first access grant selection for a first image from the plurality of restricted access images stored on the server computer for the second user; and,
associating the first access grant selection and the first image from the plurality of restricted access images stored on the server computer with the second user.

29. The system of claim 28, wherein the method further comprising:
receiving, from the second user, a retrieval request to retrieve the plurality of restricted access images stored on the server computer;
determining the first image from the plurality of restricted access images stored on the server computer associated with the first access grant selection and the second user; and,
providing access to the first image.

30. The system of claim 28, wherein the method further comprising:
receiving, from a third user, a second request to access the plurality of restricted access images stored on the server computer;
presenting, to the first user, the second request from the third user to access the plurality of restricted access images stored on the server computer;
receiving, from the first user, a second access grant selection for a second image from the plurality of restricted access images stored on the server computer for the third user; and,
associating the second access grant selection and the second image from the plurality of restricted access images stored on the third computer with the third user.

31. The system of claim 28, wherein the plurality of restricted access images are selected from a plurality of non-restricted access images stored on the server computer.

32. A method for a first user to manage access, by a second user, of a plurality of restricted access images, the method comprising:
receiving, from the second user, an access request to access the plurality of restricted access images;
presenting, to the first user, the request from the second user to access the plurality of restricted access images;
receiving, from the first user, a first access grant selection for a first image from the plurality of restricted access images for the second user; and,
associating the first access grant selection and the first image from the plurality of restricted access images with the second user.

33. The method of claim 32, further comprising:
receiving, from the second user, a retrieval request to retrieve the plurality of restricted access images;
determining the first image from the plurality of restricted access images associated with the first access grant selection and the second user; and
displaying the first image.

34. The method of claim 32, further comprising:
receiving, from a third user, a second access request to access the plurality of restricted access images;
presenting, to the first user, the second request from the third user to access the plurality of restricted access images;
receiving, from the first user, a second access grant selection for a second image from the plurality of restricted access images for the third user; and,
associating the second access grant selection and the second image from the plurality of restricted access images with the third user.

35. The method of claim 32, wherein the plurality of restricted access images are selected from a plurality of non-restricted access images.

36. A computer readable medium comprising computer-executable code stored thereon that, when executed, implements a method for a first user to manage access, by a second user, of a plurality of restricted access images, the method comprising:
receiving, from the second user, an access request to access the plurality of restricted access images;
presenting, to the first user, the request from the second user to access the plurality of restricted access images;
receiving, from the first user, a first access grant selection for a first image from the plurality of restricted access images for the second user; and,
associating the first access grant selection and the first image from the plurality of restricted access images with the second user.

37. The computer readable medium of claim 36, wherein the method further comprising:
receiving, from the second user, a retrieval request to retrieve the plurality of restricted access images;
determining the first image from the plurality of restricted access images associated with the first access grant selection and the second user; and
providing the first image.

38. The computer readable medium of claim 36, wherein the method further comprising:
receiving, from a third user, a second access request to access the plurality of restricted access images;
presenting, to the first user, the second request from the third user to access the plurality of restricted access images;
receiving, from the first user, a second access grant selection for a second image from the plurality of restricted access images for the third user; and,
associating the second access grant selection and the second image from the plurality of restricted access images with the third user.

39. The computer readable medium of claim 36, wherein the plurality of restricted access images are selected from a plurality of non-restricted access images.
